(19) United States
(12) Patent Application Publication
(10) Pub. No.: US 2013/0013888 A1
(43) Pub. Date: Jan. 10, 2013

(54) Method and Appartus For Index-Based Virtual Addressing

(75) Inventors: HoYu Lam, Brooklyn, NY (US); Sailesh Kumar, San Jose, CA (US); William Lynch, Los Altos, CA (US)

(73) Assignee: FUTUREWEI TECHNOLOGIES, INC., Plano, TX (US)

(21) Appl. No.: 13/541,287

(22) Filed: Jul. 3, 2012

Related U.S. Application Data
(60) Provisional application No. 61/504,827, filed on Jul. 6, 2011.

(51) Int. Cl. G06F 12/10

(52) U.S. Cl. 711/206; 711/E12.061

(57) ABSTRACT

An apparatus comprising a memory configured to store a routing table and a processor coupled to the memory, the processor configured to generate a request to access at least a section of an instance, assign an index to the request based on the instance, lookup an entry in the routing table based on the index, wherein the entry comprises a resource bit vector, and identify a resource comprising at least part of the section of the instance based on the resource bit vector.

### CROSS-REFERENCE TO RELATED APPLICATIONS

The present application claims priority to U.S. Provisional Patent Application No. 61/504,827 filed Jul. 6, 2011 by HoYu Lam et al. and entitled “Method and Apparatus for Achieving Index-Based Load Balancing”, which is incorporated herein by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

In modern processor systems, physical addresses of hardware (e.g., a memory) may often be mapped or translated to virtual addresses, or vice versa. This process may be implemented in a processor and may be referred to as virtual addressing. Equipped with virtual addressing capabilities, the processor may utilize various resources such as logic units and/or memory spaces that may be located on different chips. In practice, there may be various issues that need to be addressed. For instance, a resource (e.g., a memory) may be limited in scale, thus a data structure (e.g., a large look-up table), may not fit in a single resource and may need to be partitioned among a plurality of resources. Further, the memory may not be able to expand in size indefinitely, as memory latency may rise and throughput may drop as memory size surpasses a certain threshold. It is therefore desirable to develop virtual addressing schemes which may provide high performance as well as flexibility in the configuration of processor systems.

### SUMMARY

In one embodiment, the disclosure includes an apparatus comprising a memory configured to store a routing table and a processor coupled to the memory, the processor configured to generate a request to access at least a section of an instance, assign an index to the request based on the instance, lookup an entry in the routing table based on the index, wherein the entry comprises a resource bit vector, and identify a resource comprising at least part of the section of the instance based on the resource bit vector.

In another embodiment, the disclosure includes a method comprising generating a request to access at least a section of an instance, assigning an index to the request based on the instance, looking up an entry in a routing table based on the index, wherein the entry comprises a resource bit vector, and identifying a resource comprising at least part of the section of the instance based on the resource bit vector.

In yet another embodiment, the disclosure includes an apparatus comprising a resource comprising a plurality of feature instance registers (FIRs), the resource configured to receive a request to access at least part of an instance, process the request to provide an intermediate result based on a first section of the at least part of the instance, determine a resource identification (ID) stored in a FIR, wherein the resource ID identifies a second resource comprising a second section of the at least part of the instance, and send the request and the intermediate result to the second resource.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an embodiment of a processor system.

FIG. 2 is a schematic diagram of an embodiment of a virtual addressing scheme.

FIG. 3 is a schematic diagram of an embodiment of a routing table entry.

FIG. 4 is a schematic diagram of an embodiment of an addressing scheme without instance partitioning.

FIG. 5 is a schematic diagram of an embodiment of an addressing scheme with instance partitioning.

FIG. 6 is a schematic diagram of an embodiment of an addressing scheme when an i-value equals four.

FIG. 7 is a flowchart of an embodiment of an index-based addressing method.

FIG. 8 is a flowchart of an embodiment of a chaining method.

FIG. 9 is a schematic diagram of an embodiment of a network unit.

FIG. 10 is a schematic diagram of a general-purpose computer system.

### DETAILED DESCRIPTION

It should be understood at the outset that, although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

In a processor system, a processor may generate various requests, which may be messages to access various instances of features provided by a plurality of resources. An instance (or feature instance) may refer to a data structure of any type, such as a linear table, a hash table, a lookup tree, a linked-list, a routing table (RT), etc. A resource may be used for storage of one or more instances and/or providing additional features such as decision logic units that access and manage the instances.

In current designs of processors, a translation lookaside buffer (TLB) is often used in computer systems, such as notebooks, desktops, and servers, which utilize virtual addresses. A TLB may be a cache that memory management hardware uses to improve virtual address translation speed. In use, a search key may be provided to the TLB as a virtual address. If the virtual address is present in the TLB, a physical address may be retrieved and accessed quickly, which may be called a TLB hit. If the virtual address is not present in the TLB, it may be called a TLB miss, and the physical address may be looked up in a page walk. The page walk may involve reading contents of various memory regions and using them to compute the physical address, which can be an expensive process. After the physical address is determined by the page walk, the virtual address to physical address mapping may be entered into the TLB, so it may be used in a next search.

Conventional addressing schemes, such as TLB, may carry potential limitations and/or issues. For example, a resource may not have enough remaining storage space to contain a relatively large data structure, thus additional resources may be needed. Since some conventional addressing schemes may map a data structure to a single physical resource, some entries of the data structure may not be accessible to a request. For another example, a request, such as a search request, may involve a plurality of instance entries (e.g., in different resources), thus potentially a large number of computation steps may be needed. In this case, a large number of requests and responses may need to go back and forth between the processor and the resources, which may increase memory latency and lower computation efficiency. For yet another example, additional resources may sometimes be added into an existing system, or a number of instances may be re-distributed among a plurality of resources, in this case a request may need to be modified accordingly to accommodate the new configuration of resources, which may be inconvenient.

Disclosed herein are systems and methods for index-based virtual addressing in a processor system. Via the use of a routing table in a processor, a request generated by the processor may access any instance stored in one or more of a plurality of available resources. If desired, an instance may be flexibly partitioned in the resources. The physical distribution of resources and partitioning of instances may be transparent to the request. To facilitate virtual addressing, the request may be assigned a routing table index to identify an entry of the routing table, which may correspond to an instance identification (ID). The routing table may also contain a resource bit vector, which may be configured differently, depending on whether the instance corresponding to the request is partitioned. For example, if the corresponding instance is not partitioned, the resource bit vector may directly comprise a resource ID which may designate a destination resource. Otherwise, if the corresponding instance is partitioned into different sections, the resource bit vector may contain a number of ‘1’ bits in a set of positions indicating the participating resources, which may be located and mapped to. Further, if the request is accessing more than one resource, chaining may be used to route the request to a next-hop resource, which may depend on intermediate results obtained in a current resource. By using the disclosed addressing schemes, performance (e.g., memory latency) may be improved and greater flexibility may be obtained in the configuration of the processor system.

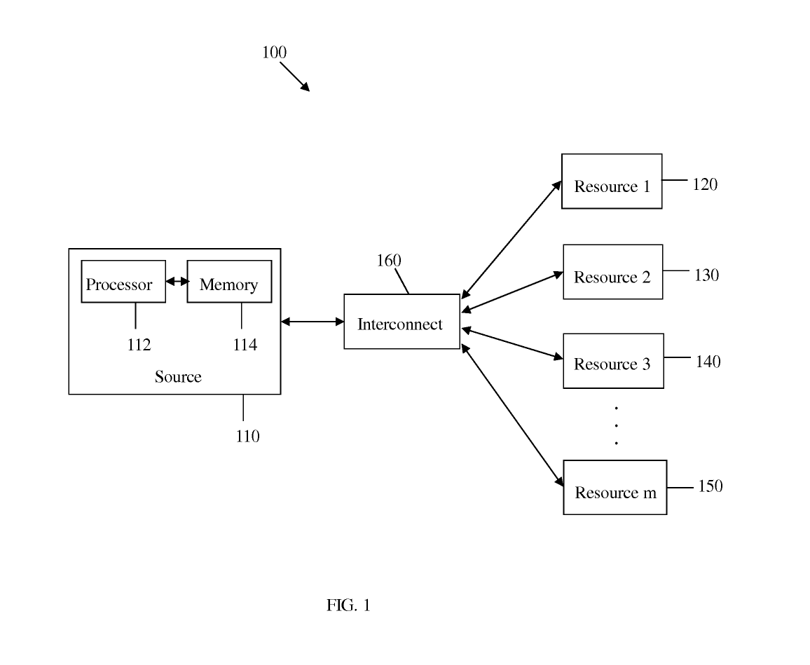

FIG. 1 shows a schematic diagram of an embodiment of a processor system 100, which comprises a source 110 connected to m resources 120-150, where m is an integer greater than one, via an interconnect 160. In use, the source 110 may generate and route various requests to the resources 120-150 in order to access various instances. The source 110 may comprise a processor 112 and a memory 114 coupled to the processor 112. A request may be generated by the processor 112 and may use any data, such as a routing table, stored in the memory 114, which may be, for example, a buffer or a cache. Although illustrated as a single processor, the processor 112 is not so limited and may comprise a plurality of processors. For example, the processor 112 may be implemented as one or more central processor unit (CPU) chips, cores (e.g., a multi-core processor), field-programmable gate arrays (FPGAs), application specific integrated circuits (ASICs), and/or digital signal processors (DSPs), and/or may be part of one or more ASICs. In practice, if the processor 120 comprises a plurality of cores, a request may be generated and sent by any of the plurality of cores.

Any two of the m resources 120-150 may be the same or different. In the interest of clarity, the resource 120 may be discussed herein as an example, with the premise that descriptions regarding the resource 120 may be equally applicable to any other resource. The resource 120 may comprise a memory (or storage) space and/or a decision logic. For instance, the resource 120 may be a smart memory, which comprises a memory space and an associated decision logic that provides access and management of specialized data structures in the memory space. Depending on the application, the resource 120 may take various forms. For example, the resource 120 may comprise a processing engine, a chip (e.g., with decision logic), and/or a memory. For another example, the resource 120 may be part of a chip. Each of the resources 120-150 may be located in a separate chip, or alternatively, two or more of the resources 120-150 may be located in a same chip. In an embodiment, upon receiving of a request, an instance corresponding to the request may be located in the memory space of the resource 120, and one or more entries of the instance may be accessed. In addition, the decision logic of the resource 120 may determine whether to perform computation (or calculation) based on the request. In the event that the request may also need to access other entries of the instance that are stored in another resource (e.g., the resource 130), the decision logic of the resource 120 may also route the request to the other resource (e.g., the resource 130) via the interconnect 160. Eventually, a response may be generated by the last resource and sent back to the source 110 via the interconnect 160. In practice, through the coordination of the logic unit, the resource 120 may simultaneously handle a variety of requests, which may access a same or different corresponding instances.

In use, the resource 120 may be an on-chip resource (i.e., on the same physical chip with the processor 112), such as cache, special function register (SFR) memory, internal random access memory (RAM), or an off-chip resource, such as external SFR memory, external RAM, a hard drive, Universal Serial Bus (USB) flash drive, etc. Further, if desired, a single chip, such as a memory, may be divided into a plurality of parts or sections, and each part may be used as a separate resource. Alternatively, if desired, a plurality of chips may be used in combination as a single resource. Thus, the virtual addressing (or routing) of a request may be performed within a single chip or across chips.

The interconnect 160 may be a communication channel or switching fabric/switch facilitating data communication between the source 110 and any of the resources 120-150, or between any two of the resources 120-150 (e.g., between the resource 120 and the resource 130). In practice, the interconnect 160 may take a variety of forms, such as one or more buses, crossbars, unidirectional rings, bidirectional rings, etc. In the event that the source 110 and a resource (e.g., the resource 120) or two of the resources 120-150 are at different locations, the interconnect 160 may be a network channel, which may be any combination of routers and other processing equipment necessary to transmit signals between the source 110 and the resources 120-150, or between two resources. The interconnect 160 may, for example, be the public Internet or a local Ethernet network. The source 110 and/or the resources 120-150 may be connected to the interconnect 160 via wired or wireless links.

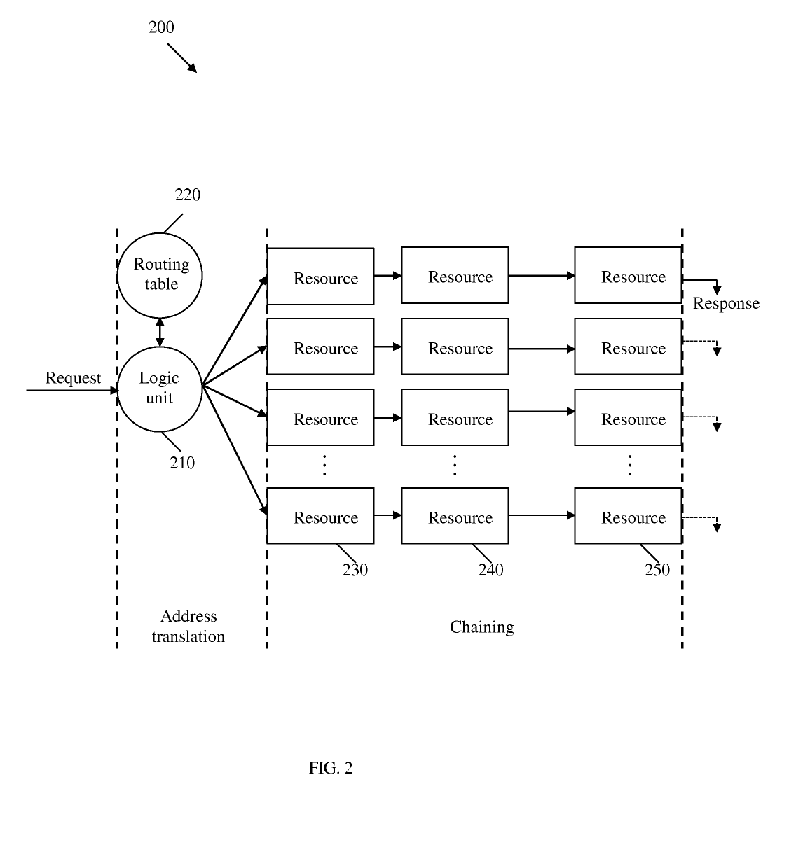

In the present disclosure, a request generated by a processor (e.g., the processor 112) may be addressed (or routed) to an instance stored in one or more of a plurality of resources (e.g., the resource 120). FIG. 2 illustrates a schematic diagram of an embodiment of a virtual addressing scheme 200. In use, a running program (or requester) in a processor may generate a request, which may comprise a header section and a data section. The header section may contain information such as a routing table index (RT_index) used by a request routing table (RT), as well as a key (or index) of an instance. The key may indicate which entry or entries of the instance may be accessed by the request. Depending on the purpose of the request, the data section may contain various data and/or instructions. For example, one or more numerical values in the data section may be compared with all (or a portion of) entries of the instance. For another example, one or more instructions in the data section may delete, modify or add one or more entries of the instance. It should be noted herein that the request may not need to contain any information regarding the distribution of resources and partitioning of the instance among resources (if any). Thus, the disclosed addressing or routing schemes may be transparent to the request.

As illustrated in FIG. 2, the request may be first fed into a library or logic unit 210, which may be located in the same processor where the request is generated (e.g., the processor 112 in FIG. 1) or a different processor. In an embodiment, the logic unit 210 may be configured to locate or identify an entry in a routing table based on the RT_index contained in the header section of the request. In an embodiment, the logic unit 210 may also be configured to generate an i-value based on the index contained in the header section of the request. The RT_index and i-value may be used in addressing the request to its destination resource, the details of which will be discussed later. After partial execution of the logic unit 210, the request may comprise the RT_index, i-value and index in its header section. In addition, a request routing table 220 may be contained in or coupled to the logic unit 210. In an embodiment, the RT_index of the request may be used to index the routing table 220, which may address the request to any of a plurality of resources available in the system, such as resources 230-250 in FIG. 2. In an embodiment, the routing table 220 may reside in a memory, such as the memory 114 in FIG. 1. The routing table 220 may reside in a same source (e.g., the source 110) with the logic unit 210. In a multi-core processor, each core may have a separate routing table. Alternatively, a portion or all of the cores may share a common routing table. The routing table 220 may contain correspondence information of instances and resources. Thus, based on the RT_index and i-value, the instance corresponding to the request (with an instance ID) may be recognized by the routing table 210, and the request may be routed to the instance accordingly.

In an embodiment, after address translation using the routing table 220, the header section of the request may comprise a destination ID, a source ID, a source tag, an instance ID, and a key or index. The destination ID may identify the destination resource which contains the corresponding instance. The source ID may identify the processor in which a response of the request may be returned. The source tag may identify the request in the source or the processor, which may be useful since a plurality of requests may be simultaneously sent from a same source and responses returned to the same source. The instance ID may be an index to feature instance registers (FIRs) in the destination resource, which will be described in more detail later.

Any resource (e.g., the resource 230) may receive the request sent by the logic unit 210. In use, any two of the resources (e.g., the resource 230 and the resource 240) in the virtual addressing scheme 200 may be the same or different. For example, the resource 230 may be the same or similar to the resource 120 in FIG. 1. The resource 230 may store a variety of instances or data structures, such as a linear table, a hash table, a B-tree, a lookup tree, etc. Further, an instance may be partitioned into a plurality of resources, with each resource storing a specific section of the instance. Any of the resources (e.g., the resource 230), after processing the request, may return a response to the requester (source, or processor).

In practice, sometimes more than one resource may be accessed before a response may be generated for a request. For example, in handling a data structure (e.g., a large look-up table) that is partitioned among a plurality of resources, a request may search for a particular value in the data structure. In this case, the request may successively go through a plurality of entries in the data structure and compare them with the search value, until the data structure is exhausted or a matching entry is located. As illustrated in FIG. 2, chaining may be used herein to facilitate accessing of multiple resources, where resources may be accessed one after another in a pipe-lined fashion. To provide chaining capability, the decision logic of each participating resource may comprise FIRs, which may contain feature specific parameters (e.g., types of instance) and the corresponding section (or partition) of the data structure.

The use of FIRs may allow similar resources to handle different data structures or different sections of data structures through simple configuration. For example, the FIRs may store one or more next-hop resource IDs. At the end of processing a request, optionally based on the results, a current resource may look up the FIRs for a next-hop resource ID, so that the request, appended with intermediate results at the current resource, may be forwarded to a next-hop resource via an interconnect, such as the interconnect 160 in FIG. 1. The original destination ID of the request may be overwritten with the next-hop resource ID. The chaining may continue until no further entries are needed. Then, the FIRs of the last resource may contain a null next-hop resource ID, prompting resource infrastructure to use the original source ID of the request as the destination ID. A response may be returned to the original source of the request.

The chaining architecture of resources may be dynamically determined based on each resource stage within a chain. For example, if the FIRs and/or decision logic in a resource (e.g., the resource 230) determines that a following resource (e.g., the resource 240) in the chain is not needed for a request, then the following resource (e.g., the resource 240) may be skipped. Instead, the request may be forwarded to a different next-hop resource in the chain (e.g., the resource 250). Although not shown in FIG. 2, an interconnect, such as the interconnect 160 in FIG. 1, may connect at least one resource to at least one second resource in a chain. For another example, if the FIRs in a resource (e.g., the resource 240) determines that no further resources are needed for a request, then a response may be directly generated at the current resource, and all following resources in the chain (e.g., the resource 240) may be skipped. Thus, in implementation, the number of resources included in a particular chain may be application dependent, and different chains may include a same or different number of resources. For example, if desired, an instance partitioned in multiple resources in a chain may be re-partitioned, so that the number of resources in the chain may change. Further, in the event that a request needs to access a plurality of instances, these instances, whether partitioned or not, may also be accessed successively in a chaining scheme.

In an embodiment, an intermediate result may be generated in a resource within the chain. The intermediate result may be passed to the next resource by modifying or adding to the original request. For example, a request may conduct a longest prefix match in an instance containing a prefix search tree, which may be partitioned among resources. In this case, if any matching prefix exists, the intermediate result may be a longest matching prefix obtained so far in earlier stages of a resource chain. The intermediate result may be passed to a later stage, where a longer matching prefix may or may not exist. The request may carry the longest matching prefix obtained so far, such that the last resource accessed by the request may have the overall longest prefix matched. In an embodiment, an intermediate result may be used to determine a next resource, but the intermediate result may not be carried by the request to the next resource. For example, in a simple binary search tree, one or more search keys of the request may be compared with entries of the binary search tree, but there may be no return values stored in intermediate resources or nodes. In an embodiment, no intermediate result may be generated by resources in a chain. In an intermediate resource, a request as received may be passed to a next resource with only a resource destination ID of the next resource in the header section. For example, in a multi-level or dimension search tree, one or more dimensions may be empty or disregarded. No intermediate result (or tree) may be needed for the empty dimensions but resources may still be allocated for them, such that the search tree may support any new item that may use the empty dimensions.

As mentioned previously, system resources such as hardware accelerators and memories may not be able to expand in size indefinitely, as memory latency may rise and throughput may drop as memory size passes a certain threshold. Thus, to accommodate throughput and capacity requirements, a portion of or an entire resource may be replicated in a plurality of resources. Consequently, the system may realize load balancing by distributing a plurality of requests accessing a same instance among the plurality of resources. In use, load balancing may be implemented in different forms using a disclosed addressing scheme. For example, if desired, a section or all of an instance may be replicated in a plurality of resources. In an embodiment, each copy of the replicated instance (or replicated section) may be labeled with a different RT_index. In the event that a plurality of requests access the replicated instance at a same or close time, each request may be assigned a different RT_index. Thus, the plurality of outstanding requests may be distributed among the plurality of resources to realize load balancing. For instance, multiple requests to read a replicated instance may be evenly distributed among resources, so that the overall throughput of the system may be improved.

Another form of load balancing may be realized when a portion or all of a decision logic in a resource is replicated among a plurality of resources. To access different sections of an instance (e.g., in a search request), which may be stored in the plurality of resources, either one request or a plurality of requests may be sent from the source. In a first case, if one request is sent from the source, an embodiment of a chaining scheme may be used, in which the same algorithm in the replicated decision logics may be used sequentially in each stage of the resource chain. In comparison to some conventional schemes, in which one request may only access one resource and the source may need to wait for a response from a resource before sending another request, throughput of the disclosed chaining scheme may be improved. For instance, the disclosed chaining scheme may only have memory latency of a few clock cycles, while a conventional scheme may have memory latency of several hundred clock cycles. In a second case, if a plurality of requests is sent from the source to the plurality of resources which include the replicated decision logics, the plurality of requests may be assigned a same RT_index and different i-values to access a plurality of partitioned sections in a same instance. In the replicated decision logics, the same algorithm may be applied to the plurality of sections of the partitioned instance simultaneously. In the second case, since the amount of instance entries may be reduced for each request, and the source may not need to wait for a response from a resource before sending another request, the overall time of completing a request may be reduced. In the second case, an embodiment of a chaining scheme may also be used. For example, if one or more requests in the plurality of requests need to access more than one resource, each of the one or more requests may be sequentially directed to the resources, and each resource may use a replicated decision logic to process the requests.

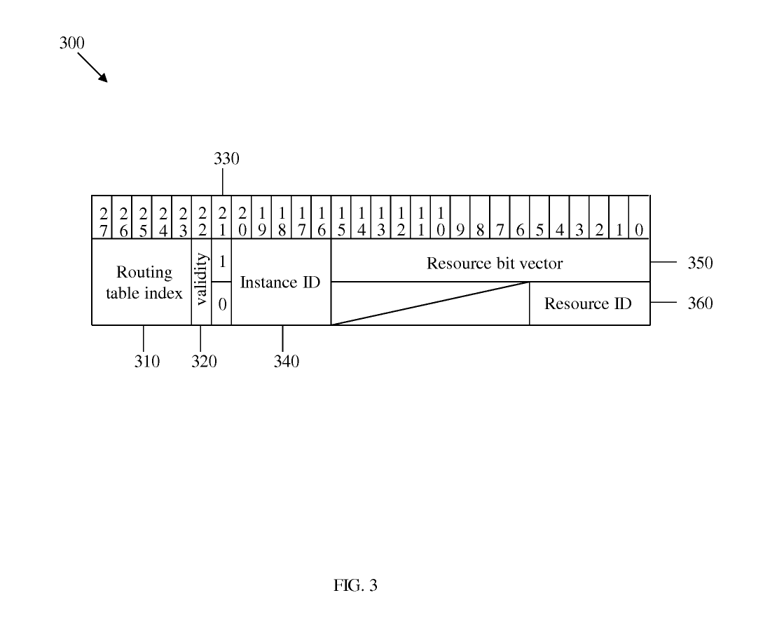

Following descriptions with respect to FIGS. 3-6 may cover more details on using a routing table for virtual addressing. FIG. 3 is a schematic diagram of an embodiment of a routing table entry 300, which may comprise a plurality of table fields, such as a routing table index (RT_index) 310, a validity field 320, an i-value validity (IV) field 330, an instance ID 340, and a resource bit vector 350. The number of bits for each field is application dependent. For example, the routing table index 310 may occupy five bits (bits 23-27), as shown in FIG. 3. The RT_index 310 may be an index of the routing table entry 300, and may be assigned to a request by a configurable logic unit (e.g., the logic unit 210 in FIG. 2). The routing table index 310 may be unique globally—across all resources, so that an instance located in any resource may be identified by the routing table entry 300. Thus, the number of entries in a routing table may depend on the maximum number of instances that a system (e.g., the processor system 100 in FIG. 1) is designed to support. It should be noted that, since an instance may be partitioned in a plurality of resources, the routing table index 310 corresponding to the partitioned instance may be shared by these resources.

After locating the routing table entry 300 from a routing table based on the RT_index 310, the validity field 320 may be checked next. The validity field 320 may occupy one bit (bit 22), and may determine whether the routing table entry 300 is valid. For example, a ‘1’ in the validity field 320 may indicate that the routing table entry 300 is a valid entry, and a ‘0’ in the validity field 320 may indicate that the routing table entry 300 is an invalid entry. The routing table entry 300 may become invalid, for example, when a certain instance is deleted. If the routing table entry 300 has a ‘0’, other entries such as the IV field 330, the instance ID 340, and the resource bit vector 350 may not be considered Likewise, the IV field 330 may occupy one bit (bit 21), and may determine whether the instance corresponding to the request is partitioned in a plurality of resources. For example, a ‘1’ in the IV field 330 may indicate that the instance is partitioned in at least two resources, and a ‘0’ in the IV field 330 may indicate that the instance is stored in only one resource.

The instance ID 340 may be determined by the RT_index 310 and may serve as an identification of an instance corresponding to the request. Since there may be a plurality of different instances (or feature instance) stored in a resource, the instance-specific parameters and data may be stored in FIRs of the assigned resources. The instance ID 340 may be used as an index of the FIRs to locate the instance corresponding to the request. It should be noted that instances stored in different resources may have a same instance ID 340. In other words, the instance ID 340 may be unique locally—within a resource, but not globally—across all resources.

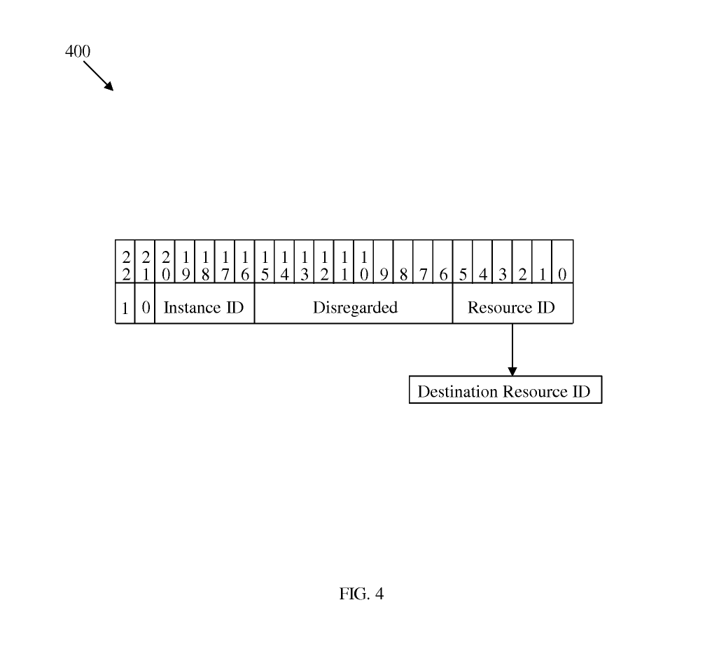

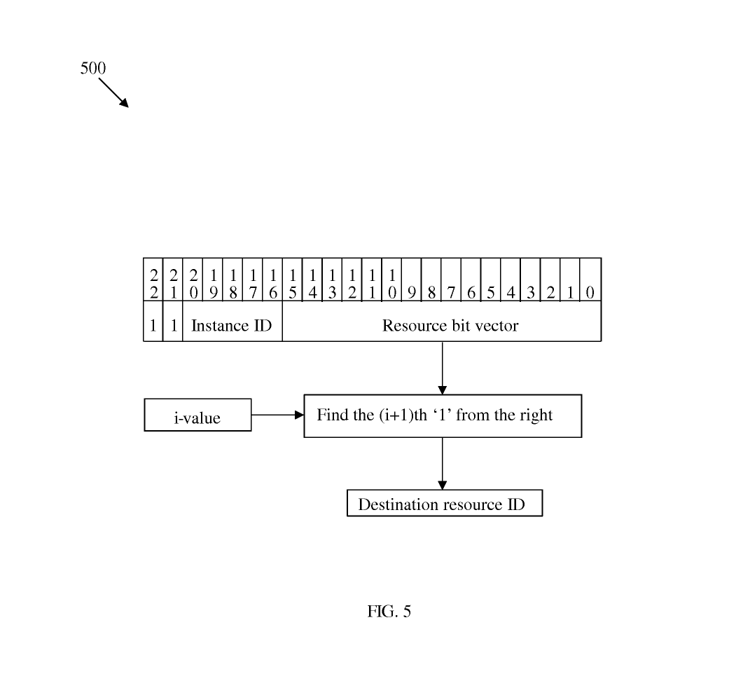

The resource bit vector 350 may indicate which resource contains the corresponding instance. Since each available resource in the system may be assigned one bit at a pre-set position in the resource bit vector 350, the number of bits may depend on the total number of resources in a processor system. For example, the resource bit vector 350 may have 16 bits (bits 0-15) corresponding to a total of 16 available resources. Depending on the value of the IV field 330 (1 or 0), the resource bit vector 350 may either directly contain a resource ID 360, or may comprise a number of ‘1’ bits which may be mapped to resources IDs. These two scenarios will be discussed in FIG. 4 and FIG. 5.

FIG. 4 is a schematic diagram of an embodiment of an addressing scheme 400 without instance partitioning (IV=0). The addressing scheme 400 may represent a specific case of the routing table entry 300, when the validity field (bit 22) is ‘1’ and the IV-field (bit 21) is ‘0’. In this case, the corresponding instance may be valid, but it may be stored in only one resource. Thus, the resource bit vector may directly contain a resource ID corresponding to the instance. For example, counting from a least significant bit (LSB) on the right side, six bits (bits 0-5) may represent the resource ID, which may identify the destination resource of the request. The upper bits (bits 6-15) of the resource bit vector may be left empty or assigned with arbitrary values, as the values of these bits may be irrelevant in this case. The number of bits used for the resource ID may depend on the number of resources available in the system. To facilitate identification of various resources, such as on-chip resources and off-chip resources, extra bits may be used in the resource ID. For example, six bits may be used for a total of 16 resources, as illustrated in FIG. 4, with four bits representing one of 16 resources and two bits used for picking an on-chip route.

FIG. 5 is a schematic diagram of an embodiment of an addressing scheme 500 with instance partitioning (IV=1). The addressing scheme 500 may represent a specific case of the routing table entry 300, when the validity field (bit 22) is ‘1’ and the IV-field (bit 21) is ‘1’. In this case, the corresponding instance may be valid, and it may be partitioned in at least two different resources. In implementation, a ‘1’ at a particular position of the resource bit vector 350 may indicate that a corresponding resource contains a section or portion of the instance, and a ‘0’ may indicate that the corresponding resource does not contain any of the instance. It is possible that, in another embodiment, a ‘0’ at a particular position of the resource bit vector 350 may indicate that a corresponding resource contains a section or portion of the instance, and a ‘1’ may indicate that the corresponding resource does not contain any of the instance. In addition, as described previously, when a request is fed into a logic unit (e.g., the logic unit 210 in FIG. 2), its header section may contain an i-value, which may be derived based on a key or index of the request. Thus, the i-value may be used in combination with the bit vector to determine the destination resource ID containing the corresponding section of the instance. In an embodiment, an i-value of i may be configured, where i is an integer. This may signal that the resource corresponding to the (i+1)th ‘1’, accounting from (including) the LSB of the resource bit vector, may contain the corresponding section of the instance. After (i+1)th ‘1’ bit is selected, the bit may be mapped to a destination resource ID, where the request may then be addressed to. Similarly, in another embodiment, the number of ‘1’s may be counted from a most significant bit (MSB) on the left side of the bit vector. In this case, an i-value of i may signal that the resource corresponding to the (i+1)th ‘1’, accounting from (including) the MSB, may contain the corresponding section of the instance.

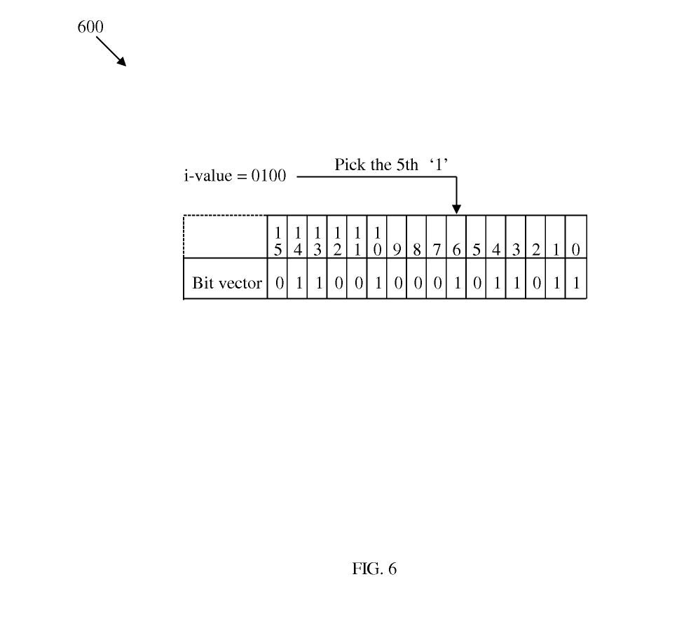

FIG. 6 is a schematic diagram of an embodiment of an addressing scheme 600 when the i-value equals four (i.e., 0100). In the addressing scheme 600, the request may be accessing one or more entries of a section of an instance, and the resource containing this section may correspond to the fifth (i.e., the (i+1)th in this case) ‘1’ in the resource bit vector counting from the LSB. Although not shown in FIG. 6, it should be noted that a similar addressing scheme may be configured, wherein the fifth ‘1’ is counted from the MSB.

In the present disclosure, the configurable i-value may allow flexible partitioning of an instance among a plurality of resources. Consider, for example, a simple data structure such as a linear table, which has 8 entries with 8 entry addresses or keys (000-111), in a processor system which has 16 available resources. In a first case, the linear table may be partitioned into 4 of the 16 resources, and each resource may contain 2 consecutive entries. The 4 resources may correspond to (counting from the LSB) bits 3, 7, 12, 15 of a resource bit vector (with bits 0-15). The bits positions may be arbitrary. Thus, a resource corresponding to bit 3 of the resource bit vector may contain keys 000 and 001 of the linear table, a resource corresponding to bit 7 of the resource bit vector may contain keys 010 and 011, a resource corresponding to bit 12 of the resource bit vector may contain keys 100 and 101, and a resource corresponding to bit 15 of the resource bit vector may contain keys 110 and 111. In the first case, an i-value (or simply i) may be configured to be (counting from the LSB) bit 1 and bit 2 of the linear table key (with bits 0-2). Therefore, i=00 for keys 000 and 001, i=01 for keys 010 and 011, i=10 for keys 100 and 101, i=11 for keys 110 and 111. Depending on which entry of the linear table a request is accessing, an i-value may be derived from the key contained in the header section of the request, and a corresponding bit may be selected from the resource bit vector. In the first case, if the request has key 000 or 001, then i=00 may be derived, and bit 3 (i.e., the first ‘1’) may be selected from the resource bit vector. Otherwise if the request has key 010 or 011, i=01 may be derived, and bit 7 (i.e., the second ‘1’) may be selected. Otherwise if the request has key 100 or 101, i=10 may be derived, and bit 13 (i.e., the third ‘1’) may be selected. Otherwise if the request has key 110 or 111, i=11 may be derived, and bit 15 (i.e., the forth ‘1’) may be selected.

Alternatively, in a second case of the linear table above, it may be partitioned into 2 of the 16 resources, which may correspond to, for example, bit 2 and bit 14 of the resource bit vector. A first resource corresponding to bit 2 may contain 3 entries with keys 000, 100, and 111 which are not consecutive, and a second resource corresponding to bit 14 may contain the remaining 5 entries with keys 001, 010, 011, 101, and 110. In this second case, an i-value (or simply i) may be configured by a logic unit, so that i=0 for keys 000, 100, and 111, and i=1 for keys 001, 010, 011, 101, and 110. Depending on which entry of the linear table a request is accessing, an i-value may be assigned to the request, and a corresponding bit may be selected from the resource bit vector. In the second case, if the request has key 000, 100, or 111, i=0 may then be assigned, and bit 2 (i.e., the first ‘1’) may be selected from the resource bit vector. Otherwise if the request has key 001, 010, 011, 101, or 110, i=1 may be assigned, and bit 14 (i.e., the second ‘1’) may be selected.

From the example of the linear table above, it may be seen that the configurable i-value may correctly address a request to its corresponding section of instance, regardless of how the instance is partitioned in a plurality of resources. If an instance needs to be re-partitioned, the i-value may simply be re-configured, while the request remains unchanged. Thus, the partitioning of the instance may be transparent to the request. Further, the disclosed addressing scheme may also allow flexible changes in resources. For example, if more resources need to be incorporated into an existing system, for example, to accommodate bigger or more data structures, the resource bit vector of the routing table may be expanded in its number of bits. One or more i-values may be re-configured accordingly, so that any request, without any change, may still be addressed to its corresponding instance (or section of instance) correctly. Thus, the physical distribution of resources may be a “black-box” to the request.

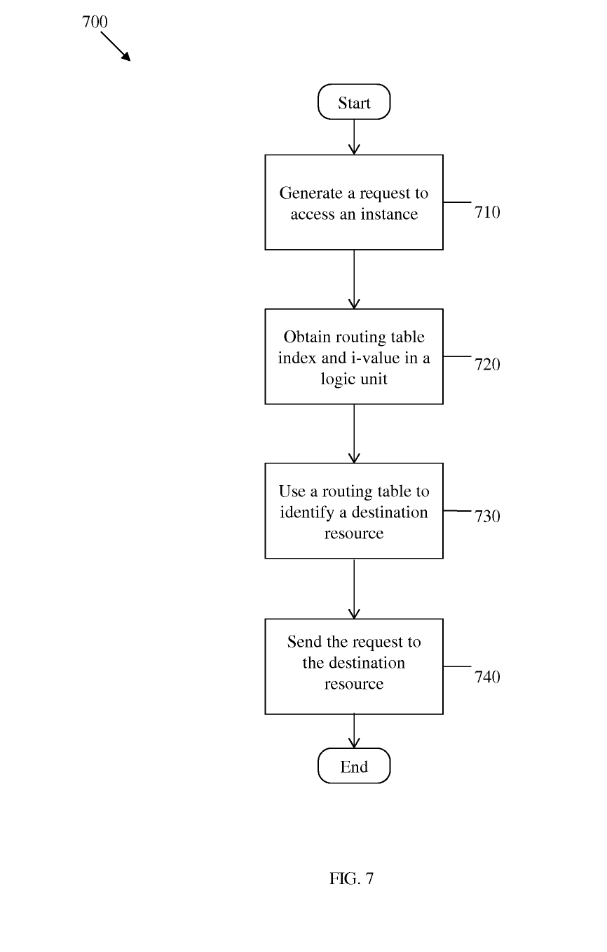

FIG. 7 is a flowchart of an embodiment of an index-based addressing method 700, which may be implemented in a processor (e.g., the processor 112 in FIG. 1). The method 700 may start in step 710, where a running program in the processor may generate a request to access one or more entries of an instance. The request may contain in its header section information such as a routing table index and/or one or more keys (or addresses) of the corresponding instance. The corresponding instance may be located in any of a plurality of resources present in a processing system. Next, in step 720, the request may be fed into a configurable logic unit (e.g., the logic unit 210 in FIG. 2), where the header section of the request may be utilized to generate an i-value. In use, a plurality of routing table indexes and/or i-values may be pre-configured based on the distribution and/or partitioning of all instances in the resources. In an embodiment, an i-value may be assigned to the request based on its key(s).

Next, in step 730, a routing table may be used to identify a destination resource whereto the request may be addressed. The routing table may be located in the same processor where the request is generated. Based on the RT_index provided by the request, the routing table may locate a routing table entry, which may comprise various fields. In an embodiment, a routing table entry, such as the routing table entry 300 in FIG. 3, may comprise the RT_index, a validity field, an i-value validity field, an instance ID and a resource bit vector. Depending on whether the instance corresponding to the request is partitioned among a plurality of resources, the resource bit vector may be configured differently. For example, if the corresponding instance is not partitioned, the resource bit vector may directly comprise a resource ID, which may designate the destination resource. Otherwise if the corresponding instance is partitioned into a plurality of sections, which may have different or replicated data, stored in a plurality of resources, the resource bit vector may include a number of ‘1’ bits in a set of positions. Each available resource in the system may be assigned to a particular position in the resource bit vector, thus a ‘1’ bit at a certain position may indicate that the corresponding resource of this position may store a section of the partitioned instance. The i-value obtained in step 720 may be used to here in conjunction with the resource bit vector, in order to determine which bit points to a resource that contains the corresponding instance section. A mapping scheme may translate the bit to a corresponding destination resource ID, which may identify the destination resource. Next, in step 740, the request may be sent from the processor to the destination resource via an interconnect, such as the interconnect 160 in FIG. 1. In an embodiment, as seen at the interconnect, the header section of the request may comprise a source ID, a source tag, the destination ID, the instance ID, and the key.

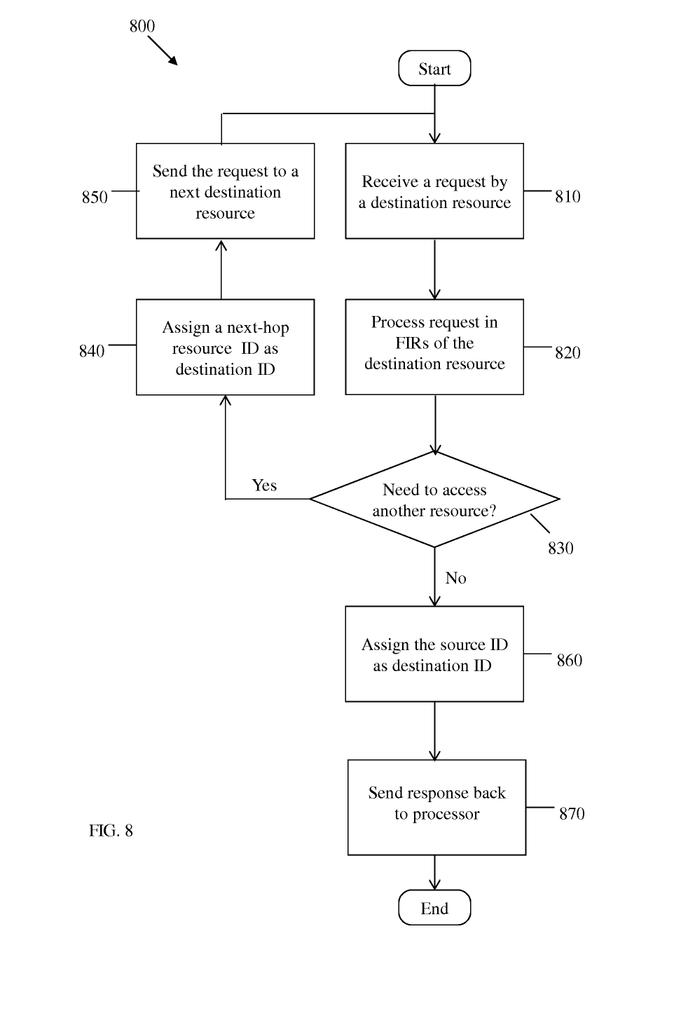

FIG. 8 is a flowchart of an embodiment of a chaining method 800, which may be implemented in a resource (e.g., the resource 120 in FIG. 1). The method 800 may start in step 810, where a request may be received by a destination resource. One or more receivers may be included in the destination resource to facilitate receiving of the request. Next, in step 820, the request may be processed in FIRs of the destination resource. The FIRs may be located in a decision logic (or logic unit) of the destination resource, which may perform computations based on the request. By using an instance ID and a key provided by the request, the FIRs may fetch one or more entries from the corresponding instance (or section of instance). If needed, an intermediate result may be generated and/or passed by the destination resource.

After processing a request, next in step 830, the method 800 may determine if the request needs to access another resource before a response can be generated. If the condition in the block 830 is met, the method 800 may proceed to step 840. Otherwise, the method 800 may proceed to step 860. In step 840, a next-hop resource ID in a chain may be looked up in the FIRs and assigned to the request. This next-hop resource ID may overwrite the original destination resource ID of the request. Next, in step 850, the request may be sent via an interconnect, such as the interconnect 160 in FIG. 1, from the original destination resource to a next destination resource, which may be identified by the next-hop resource ID. After step 850, the method may return to step 810, where the request may again be received and processed. It should be noted that, according to the present disclosure, based on intermediate result of each resource stage within a chain, the next-hop resource ID may be dynamically determined. Thus, certain resources corresponding to certain sections of the instance may potentially be skipped. In practice, the chaining may continue until the request is processed by a last resource in the chain. Next, in step 860, FIRs of the last resource may contain a NULL next-hop resource ID, and the original source ID of the request may be assigned to the request as its destination ID. Next, in step 870, a response may be sent from the last resource to the original source of the request via an interconnect, such as the interconnect 160 in FIG. 1.

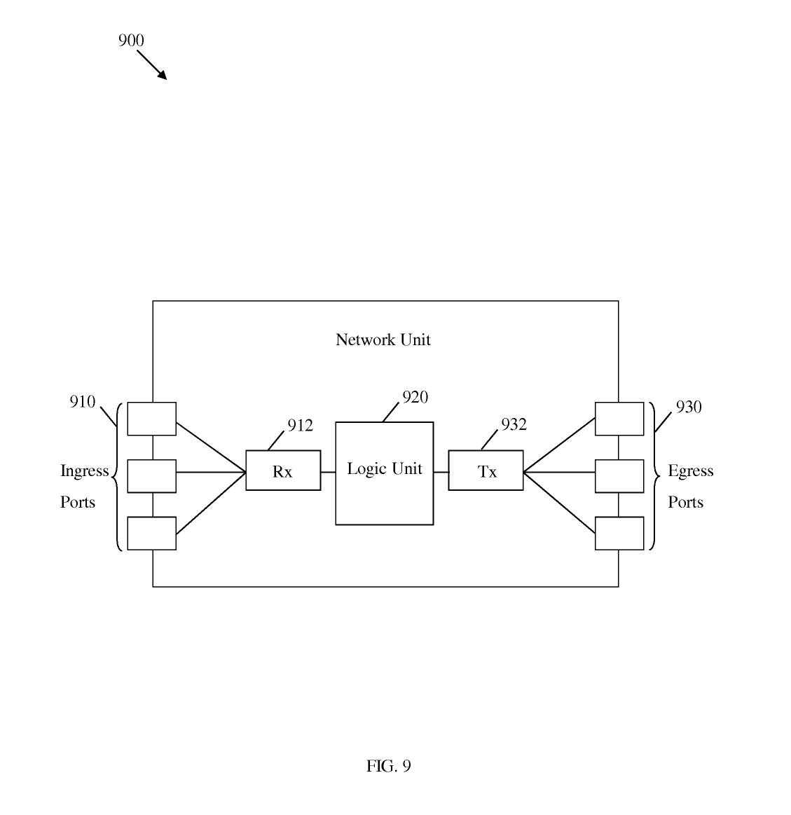

FIG. 9 illustrates a schematic diagram of an embodiment of a network unit 900, which may comprise a processor or a resource that processes requests and feature instances as described above, for example, within a network or system. The network unit 900 may comprise a plurality of ingress ports 910 and/or receiver units (Rx) 912 for receiving data from other network units or components, logic unit or processor 920 to process data and determine which network unit to send the data to, and a plurality of egress ports 930 and/or transmitter units (Tx) 932 for transmitting data to the other network units. The logic unit or processor 920 may be configured to implement any of the schemes described herein, such as the index-based addressing method 700, and may be implemented using hardware, software, or both.

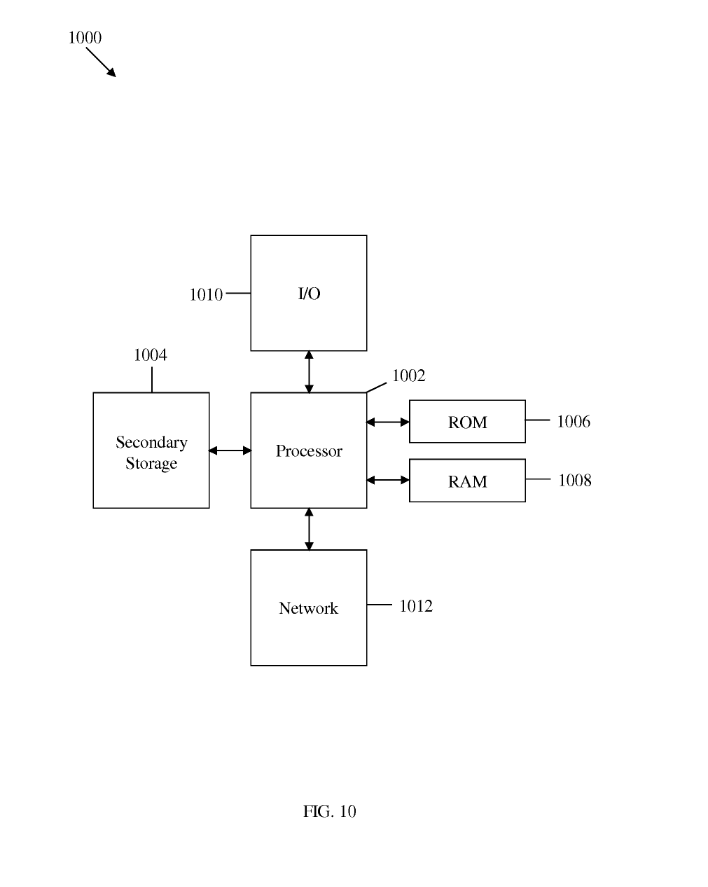

The schemes described above may be implemented on any general-purpose network component, such as a computer or network component with sufficient processing power, memory resources, and network throughput capability to handle the necessary workload placed upon it. FIG. 10 illustrates a schematic diagram of a typical, general-purpose network component or computer system 1000 suitable for implementing one or more embodiments of the methods disclosed herein, such as the index-based addressing method 700. The general-purpose network component or computer system 1000 includes a processor 1002 (which may be referred to as a central processor unit or CPU) that is in communication with memory devices including secondary storage 1004, read only memory (ROM) 1006, random access memory (RAM) 1008, input/output (I/O) devices 1010, and network connectivity devices 1012. Although illustrated as a single processor, the processor 1002 is not so limited and may comprise multiple processors. The processor 1002 may be implemented as one or more CPU chips, cores (e.g., a multi-core processor), field-programmable gate arrays (FPGAs), application specific integrated circuits (ASICs), and/or digital signal processors (DSPs), and/or may be part of one or more ASICs. The processor 1002 may be configured to implement any of the schemes described herein, including the index-based addressing method 700, which may be implemented using hardware, software, or both.

The secondary storage 1004 is typically comprised of one or more disk drives or tape drives and is used for non-volatile storage of data and as an over-flow data storage device if the RAM 1008 is not large enough to hold all working data. The secondary storage 1004 may be used to store programs that are loaded into the RAM 1008 when such programs are selected for execution. The ROM 1006 is used to store instructions and perhaps data that are read during program execution. The ROM 1006 is a non-volatile memory device that typically has a small memory capacity relative to the larger memory capacity of the secondary storage 1004. The RAM 1008 is used to store volatile data and perhaps to store instructions. Access to both the ROM 1006 and the RAM 1008 is typically faster than to the secondary storage 1004.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, i.e., k is 1 percent, 2 percent, 3 percent, 4 percent, 7 percent, . . . , 70 percent, 71 percent, 72 percent, . . . , 95 percent, 96 percent, 97 percent, 98 percent, 99 percent, or 100 percent. Moreover, any numerical range defined by two R numbers as defined in the above is also specifically disclosed. The use of the term about means±10% of the subsequent number, unless otherwise stated. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

What is claimed is:

1. An apparatus comprising:
a memory configured to store a routing table; and
a processor coupled to the memory, the processor configured to:
generate a request to access at least a section of an instance;
assign an index to the request based on the instance;
lookup an entry in the routing table based on the index, wherein the entry comprises a resource bit vector; and
identify a resource comprising at least part of the section of the instance based on the resource bit vector.

2. The apparatus of claim 1, wherein the processor is further configured to generate a value based on the request, and wherein the resource is further based on the value.

3. The apparatus of claim 2, wherein the request comprises a header section comprising at least one key, and wherein the value is based on the key.

4. The apparatus of claim 3, wherein the instance is partitioned into a set of resources including the resource, wherein the resource bit vector comprises a number of ‘1’-valued bits equal to a number of resources in the set of resources, wherein a position of an ‘1’-valued bit within the resource bit vector is determined based on the value, and wherein the resource is identified based on the position.

5. The apparatus of claim 4, wherein the entry further comprises an instance identification (ID), and wherein the instance ID is determined based on the index.

6. The apparatus of claim 5, wherein the entry further comprises a validity field, wherein the resource bit vector is only considered when the validity field is valid.

7. The apparatus of claim 4, wherein when the value equals i, where i is an integer, the position corresponds to a (i+1)th ‘1’-valued bit counting from a least significant bit (LSB) of the resource bit vector.

8. The apparatus of claim 4, wherein when the value equals i, where i is an integer, the position corresponds to a (i+1)th ‘1’-valued bit counting from a most significant bit (MSB) of the resource bit vector.

9. The apparatus of claim 3, wherein the instance is partitioned into a set of resources including the resource, wherein the resource bit vector comprises a number of ‘0’-valued bits equal to a number of resources in the set of resources, wherein a position of an ‘0’-valued bit within the resource bit vector is determined based on the value, and wherein the resource is identified based on the position.

10. The apparatus of claim 1, wherein the resource bit vector comprises a resource ID identifying the resource.

11. A method comprising:
generating a request to access at least a section of an instance;
assigning an index to the request based on the instance;
looking up an entry in a routing table based on the index, wherein the entry comprises a resource bit vector; and
identifying a resource comprising at least part of the section of the instance based on the resource bit vector.

12. The method of claim 11, further comprising generating a value based on the request, wherein the resource is further based on the value.

13. The method of claim 12, wherein the request comprises a header section comprising at least one key, and wherein the value is based on the key.

14. The method of claim 13, wherein the instance is partitioned into a set of resources including the resource, wherein the resource bit vector comprises a number of ‘1’-valued bits equal to a number of resources in the set of resources, wherein a position of an ‘1’-valued bit within the resource bit vector is determined based on the value, and wherein the resource is identified based on the position.

15. The method of claim 14, wherein the entry further comprises an instance identification (ID), and wherein the instance ID is determined based on the index.

16. The method of claim 15, wherein the entry further comprises a validity field, wherein the resource bit vector is only considered when the validity field is valid.

17. The method of claim 14, wherein when the value equals i, where i is an integer, the position corresponds to a (i+1)th ‘1’-valued bit counting from a least significant bit (LSB) of the resource bit vector.

18. The apparatus of claim 14, wherein when the value equals i, where i is an integer, the position corresponds to a (i+1)th ‘1’-valued bit counting from a most significant bit (MSB) of the resource bit vector.

19. The method of claim 13, wherein the instance is partitioned into a set of resources including the resource, wherein the resource bit vector comprises a number of ‘0’-valued bits equal to a number of resources in the set of resources, wherein a position of an ‘0’-valued bit within the resource bit vector is determined based on the value, and wherein the resource is identified based on the position.

20. The method of claim 11, wherein the resource bit vector comprises a resource ID identifying the resource.

21. An apparatus comprising:
a resource comprising a plurality of feature instance registers (FIRs), the resource configured to:
receive a request to access at least part of an instance;
process the request based on a first section of the at least part of the instance;
determine a resource identification (ID) stored in a FIR, wherein the resource ID identifies a second resource comprising a second section of the at least part of the instance; and
send the request to the second resource.

22. The apparatus of claim 21, wherein the FIRs comprise a plurality of resource identifications (IDs), wherein the plurality of resource IDs identify a plurality of resources including the additional resource, wherein the resource ID is selected from the plurality of resource IDs.

23. The apparatus of claim 22, further comprising:
a memory configured to store a routing table; and
a processor coupled to the memory, the processor configured to:
generate the request;
assign an index to the request based on the instance;
lookup an entry in the routing table based on the index, wherein the entry comprises a resource bit vector; and
identify the resource based on the resource bit vector.

24. The apparatus of claim 23, wherein the request comprises a header section comprising at least one key of the instance, and wherein the resource is identified further based on a value derived from the key.

25. The apparatus of claim 24, wherein the instance is partitioned into a set of resources including the resource and the second resource, wherein the set of resources comprise a plurality of sections of the instance including the first section and the second section, wherein the resource bit vector comprises a number of ‘1’-valued bits equal to a number of resources in the set of resources, wherein a position of an ‘1’-valued bit within the resource bit vector is determined based on the value, and wherein the resource is identified based on the position.

26. The apparatus of claim 25, wherein the entry further comprises:
an instance identification (ID), wherein the instance ID is determined based on the index;
an i-value validity (IV) field, wherein the value is only considered when the IV field is valid; and
a validity field, wherein the resource bit vector is only considered when the validity field is valid.

27. The apparatus of claim 25, wherein when the value equals i, where i is an integer, the position corresponds to a (i+1)th ‘1’-valued bit counting from a least significant bit (LSB) of the resource bit vector.

28. The apparatus of claim 25, wherein when the value equals i, where i is an integer, the position corresponds to a (i+1)th ‘1’-valued bit counting from a most significant bit (MSB) of the resource bit vector.

29. The apparatus of claim 24, wherein the instance is partitioned into a set of resources including the resource and the second resource, wherein the set of resources comprise a plurality of sections of the instance including the first section and the second section, wherein the resource bit vector comprises a number of ‘0’-valued bits equal to a number of resources in the set of resources, wherein a position of an ‘0’-valued bit within the resource bit vector is determined based on the value, and wherein the resource is identified based on the position.
